(19) United States
(12) Patent Application Publication
(10) Pub. No.: US 2022/0414581 A1
(43) Pub. Date: Dec. 29, 2022

(54) INFORMATION PROCESSING METHOD AND INFORMATION PROCESSING SYSTEM

(71) Applicant: PANASONIC INTELLECTUAL PROPERTY MANAGEMENT CO., LTD., Osaka (JP)

(72) Inventors: Changhui YANG, Osaka (JP); Masaharu AMAIKE, Osaka (JP); Takashi IIDA, Hyogo (JP); Shinya NISHIKAWA, Osaka (JP); Takashi MATSUDA, Osaka (JP)

(21) Appl. No.: 17/762,297

(22) PCT Filed: Jul. 27, 2020
(86) PCT No.: PCT/JP2020/028694

§ 371 Date: Mar. 21, 2022

(30) Foreign Application Priority Data
Sep. 27, 2019 (JP) 2019-177139

(51) Int. Cl. G06Q 10/06; G06Q 10/08

(52) U.S. Cl. CPC G06Q 10/063114; G06Q 10/083; B60L 58/12

(57) ABSTRACT

Provided is an information processing method executed by a computer, the information processing method including: acquiring a delivery destination of each of packages; acquiring candidates for a stop place for a mobile body that delivers the packages to stop; determining a group to which at least one delivery destination belongs based on a location of each of the delivery destinations; determining a stop place for the group based on a location of the at least one delivery destination belonging to the group and the candidates for the stop place; and outputting the stop place determined.

### TECHNICAL FIELD

The present disclosure relates to a technique for determining a stop place of a mobile body that delivers a plurality of packages.

### BACKGROUND ART

There has been disclosed a technique of managing a usage status of a parking slot of a parking lot with a server (e.g., see Patent Literature 1) in a vehicle allocation system using the parking lot of an apartment building as a vehicle allocation destination of a rental vehicle, the technique being to prevent failing to allocate a rental vehicle due to occupation of a parking slot of another vehicle, for example.

Unfortunately, the conventional technique described above is less likely to guide a mobile body, which delivers a plurality of packages, to a stop place suitable for delivery, and thus further improvement is required.

### CITATION LIST

### Patent Literature

Patent Literature 1: JP 2014-211778 A

### SUMMARY OF INVENTION

The present disclosure is made to solve the above problem, and an object of the present disclosure is to provide a technique capable of guiding a mobile body, which delivers a plurality of packages, to a stop place suitable for delivery.

An information processing method according to an aspect of the present disclosure is executed by a computer, the information processing method including: acquiring a delivery destination of each of packages; acquiring candidates for a stop place for a mobile body that delivers the packages to stop; determining a group to which at least one delivery destination belongs based on a location of each of the delivery destinations; determining the stop place for the group based on a location of the at least one delivery destination belonging to the group and the candidates for the stop place; and outputting the stop place determined.

The present disclosure enables guiding a mobile body, which delivers a plurality of packages, to a stop place suitable for delivery.

### BRIEF DESCRIPTION OF DRAWINGS

FIG. 1 is a diagram illustrating a general configuration of an information processing system according to a first embodiment of the present disclosure.

FIG. 2 is a diagram illustrating an example of a configuration of a delivery information terminal according to the first embodiment of the present disclosure.

FIG. 3 is a diagram illustrating an example of a configuration of a delivery vehicle according to the first embodiment of the present disclosure.

FIG. 4 is a diagram illustrating an example of a configuration of a server in the first embodiment of the present disclosure.

FIG. 5 is a flowchart for illustrating stop place presentation processing of the delivery information terminal and the server in the first embodiment of the present disclosure.

FIG. 6 is a schematic diagram for illustrating the stop place presentation processing in the first embodiment of the present disclosure.

FIG. 7 is a diagram illustrating an example of a configuration of a delivery information terminal according to a second embodiment of the present disclosure.

FIG. 8 is a diagram illustrating an example of a configuration of a server in the second embodiment of the present disclosure.

FIG. 9 is a flowchart for illustrating stop place presentation processing of the delivery information terminal and the server in the second embodiment of the present disclosure.

FIG. 10 is a schematic diagram for illustrating the stop place presentation processing in the second embodiment of the present disclosure.

### DESCRIPTION OF EMBODIMENTS

(Underlying Knowledge of the Present Disclosure)

The conventional technique described above is configured such that when vehicle rental service is reserved for a vehicle allocation reservation server and a parking slot of a parking lot is designated as a vehicle allocation destination of a rental vehicle, determination means determines whether the parking slot of the parking lot is available for vehicle allocation of the rental vehicle at a vehicle allocation date and time, and then the vehicle allocation reservation server accepts the reservation of the vehicle rental service when the parking slot of the parking lot is available for the vehicle allocation of the rental vehicle at the vehicle allocation date and time as a result of the determination.

When a mobile body delivers packages, a deliverer stops the mobile body at a predetermined stop place, and then delivers the packages to respective delivery destinations. At this time, the stop place away from the delivery destination requires the deliverer to take time for delivery, and thus efficiently delivery is difficult. Thus, when the stop place is determined, a delivery destination of each of the packages needs to be considered.

Unfortunately, although the conventional technique described above considers whether the parking slot of the parking lot is available for the vehicle allocation date and time of the rental vehicle, the delivery destination of each of the packages is not considered. Thus, the conventional technique described above is less likely to guide a mobile body, which delivers a plurality of packages, to a stop place suitable for delivery.

To solve the above problem, an information processing method according to an aspect of the present disclosure is executed by a computer, the information processing method including: acquiring a delivery destination of each of packages; acquiring candidates for a stop place for a mobile body that delivers the packages to stop; determining a group to which at least one delivery destination belongs based on a location of each of the delivery destinations; determining the stop place for the group based on a location of the at least one delivery destination belonging to the group and the candidates for the stop place; and outputting the stop place determined.

Here, it is assumed that a mobile body is stopped at a stop place, and a deliverer such as a person or a robot on the mobile body carries a package from the stop place to a delivery destination. For this situation, the above configuration determines a group to which at least one delivery destination belongs based on a location of each of the delivery destinations, and then determines a stop place for each group based on a location of the at least one delivery destination belonging to the group and candidates for the stop place. This configuration enables guiding a mobile body, which delivers a plurality of packages, to a stop place suitable for delivery. Thus, the plurality of packages can be delivered more efficiently.

The above information processing method may be configured such that in the determining the stop place, the stop place is determined based on a distance from the candidate for the stop place to each of the at least one delivery destination belonging to the group.

This configuration determines a candidate for the stop place having the shortest total distance between the candidate for the stop place and the at least one delivery destination belonging to the group is determined as the stop place, for example, so that the package can be more efficiently delivered to the at least one delivery destination belonging to the group.

The above information processing method may be configured such that an area corresponding to the group is further determined, and a candidate for the stop place in the determined area is acquired in the acquiring the candidate for the stop place.

This configuration allows candidates for the stop place in the area corresponding to the group to be acquired, so that the candidates for the stop place can be further reduced in number, and thus time required for processing of determining the stop place from among the candidates for the stop place can be shortened.

The above information processing method may be configured such that a delivery time to each of the delivery destinations is further acquired, and in the determining the group, the group is determined based on a location of each of the delivery destinations and the delivery time to each of the delivery destinations.

This configuration allows not only the location of each of the delivery destinations but also the delivery time to each of the delivery destinations to be considered, so that a plurality of delivery destinations having the same delivery time can be determined as the same group, for example, and thus packages can be more efficiently delivered to the plurality of delivery destinations belonging to the group.

The above information processing method may be configured such that a location of the mobile body is further acquired, and in the determining the group, the group is determined based on the location of the mobile body, the location of each of the delivery destinations, and the delivery time to each of the delivery destinations.

This configuration allows delivery destinations within a predetermined distance from a current location of the mobile body and identical in delivery time are determined as one group, for example, so that a package can be more efficiently delivered to at least one delivery destination belonging to the group.

The above information processing method may be configured such that a movement plan passing through the stop place determined is further created, and the created movement plan is output.

This configuration allows the movement plan passing through the stop place determined to be created and the created movement plan to be output, so that a deliverer can efficiently deliver a package by moving according to the mobile plan.

The above information processing method may be configured such that a movement plan of the mobile body is created, and in the determining the stop place, the stop place is determined further using the movement plan in the determining the stop place.

This configuration allows the movement plan of the mobile body to be created before the stop place is determined, and a stop place closer to a movement route of the mobile body to be determined, for example, so that the mobile body can be efficiently moved.

The above information processing method may be configured such that remaining capacity of a battery mounted on the mobile body that is an electric mobile body is further acquired, and in the determining the stop place, the stop place is determined by further using the remaining capacity of the battery.

This configuration allows the remaining capacity of the battery mounted on the mobile body to be acquired, and the stop place to be determined by further using the remaining capacity of the battery, so that the mobile body can be prevented from stopping in the middle of movement due to zero of the remaining capacity of the battery. This configuration also enables suppressing deterioration of the battery due to excessive or insufficient remaining capacity of the battery.

The above information processing method may be configured such that in the determining the stop place, when the remaining capacity of the battery is equal to or less than a threshold, the stop place capable of charging is determined in the determining the stop place.

This configuration allows the stop place capable of charging to be determined when the remaining capacity of the battery is equal to or less than the threshold, so that the battery of the mobile body can be charged at the stop place. Thus, delivery efficiency of a package can be further improved.

An information processing system according to another aspect of the present disclosure includes: a delivery destination acquisition unit that acquires a delivery destination of each of packages; a stop place candidate acquisition unit that acquires candidates for a stop place for a mobile body that delivers the packages to stop; a group determination unit that determines a group to which at least one delivery destination belongs based on a location of each of the delivery destinations; a stop place determination unit that determines the stop place for the group based on a location of the at least one delivery destination belonging to the group and the candidates for the stop place; and an output unit that outputs the stop place determined.

Here, it is assumed that a mobile body is stopped at a stop place, and a deliverer such as a person or a robot on the mobile body carries a package from the stop place to a delivery destination. For this situation, the above configuration determines a group to which at least one delivery destination belongs based on a location of each of the delivery destinations, and then determines a stop place for each group based on a location of the at least one delivery destination belonging to the group and candidates for the stop place. This configuration enables guiding a mobile body, which delivers a plurality of packages, to a stop place suitable for delivery. Thus, the plurality of packages can be delivered more efficiently.

Hereinafter, embodiments of the present disclosure will be described with reference to the accompanying drawings. The following embodiments are merely examples embodying the present disclosure, and do not limit the technical scope of the present disclosure.

### First Embodiment

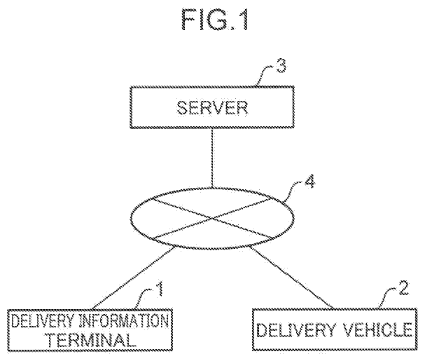

FIG. 1 is a diagram illustrating a general configuration of an information processing system according to a first embodiment of the present disclosure.

The information processing system illustrated in FIG. 1 includes a delivery information terminal 1, a delivery vehicle 2, and a server 3.

The delivery information terminal 1 is, for example, a smartphone, a tablet computer, or a terminal manufactured for a deliverer, and is used by the deliverer. The deliverer carries the delivery information terminal 1 and delivers a plurality of packages in a delivery area allocated in advance. The delivery information terminal 1 stores delivery information on a plurality of packages to be delivered by the deliverer. The delivery information includes, for example, a package ID for identifying a package, a delivery destination of the package, a delivery time of the package, and a delivery status indicating whether the delivery of the package has been completed. The delivery information terminal 1 is communicably connected to the delivery vehicle 2 and the server 3 via a network 4. The network 4 is, for example, the Internet.

The delivery vehicle 2 is an example of a mobile body. The delivery vehicle 2 includes a cargo bed on which a plurality of packages is loaded. The delivery vehicle 2 is, for example, an electric car or an electric motorcycle, and delivers a plurality of packages. The delivery vehicle 2 is operated by a user (deliverer). The delivery vehicle 2 is communicably connected to the delivery information terminal 1 and the server 3 via the network 4.

The delivery vehicle 2 is not limited to an electric car or an electric motorcycle, and may be a car or a motorcycle equipped with an internal combustion engine. The delivery vehicle 2 may be an automatic driving vehicle.

The server 3 is, for example, a web server. The server 3 receives various kinds of information from the delivery information terminal 1 and the delivery vehicle 2 and transmits various kinds of information to the delivery information terminal 1 and the delivery vehicle 2. The server 3 determines a stop place of the delivery vehicle 2 based on the information received from the delivery information terminal 1, and outputs the stop place determined to the delivery information terminal 1.

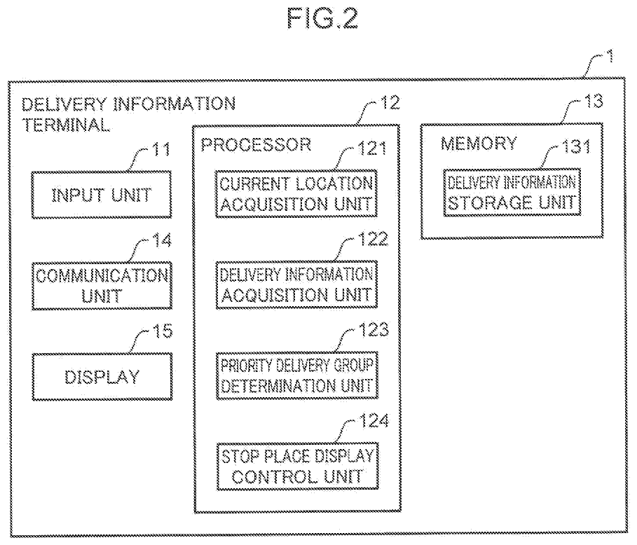

FIG. 2 is a diagram illustrating an example of a configuration of the delivery information terminal according to the first embodiment of the present disclosure.

The delivery information terminal 1 illustrated in FIG. 2 includes an input unit 11, a processor 12, a memory 13, a communication unit 14, and a display 15.

The input unit 11 is, for example, a touch panel, and receives various kinds of information input by the user.

The memory 13 is a storage device capable of storing various kinds of information, such as a random access memory (RAM), a solid state drive (SSD), or a flash memory. The memory 13 includes a delivery information storage unit 131.

The delivery information storage unit 131 stores delivery information. The delivery information includes, for example, a package ID for identifying a package, a delivery destination of the package, a delivery time of the package, and a delivery status indicating whether the delivery of the package has been completed. The delivery information storage unit 131 stores delivery information in which a package ID, a delivery destination, a scheduled delivery time, and a delivery status are associated with each other in a table format.

The processor 12 is, for example, a central processing unit (CPU), and includes a current location acquisition unit 121, a delivery information acquisition unit 122, a priority delivery group determination unit 123, and a stop place display control unit 124.

The current location acquisition unit 121 acquires a location of the delivery vehicle 2. The current location acquisition unit 121 acquires current location information transmitted by the delivery vehicle 2 from the communication unit 14.

The delivery information acquisition unit 122 acquires a delivery destination of each of packages. The delivery information acquisition unit 122 also acquires a delivery time to each delivery destination. The delivery time is represented by a delivery time zone designated in advance by a delivery source, such as a time zone in the morning, a time zone from 14:00 to 16:00, or a time zone from 16:00 to 18:00. The delivery time zone may not be designated. When the delivery time zone is not designated, all the time zones are allowable delivery time zones.

The priority delivery group determination unit 123 determines a priority delivery group to which at least one delivery destination belongs based on a location of the delivery vehicle 2, a location of each delivery destination, and a delivery time to each delivery destination. The priority delivery group determination unit 123 extracts at least one delivery destination in which a distance between the location of the delivery destination and the current location of the delivery vehicle 2 is within a predetermined distance and in which the delivery time zone includes the current time, and determines a priority delivery group to which the extracted at least one delivery destination belongs.

The stop place display control unit 124 causes the display 15 to display the location of the stop place for the delivery vehicle 2 to stop. The stop place display control unit 124 causes the display 15 to display stop place location information received by the communication unit 14.

The communication unit 14 transmits information to the server 3 and receives information from the server 3 and the delivery vehicle 2. The communication unit 14 receives current location information indicating a current location of the delivery vehicle 2 from the delivery vehicle 2. The communication unit 14 transmits delivery destination information indicating a delivery destination belonging to the priority delivery group to the server 3. The communication unit 14 receives stop place location information indicating a location of the stop place of the delivery vehicle 2 from the server 3. The communication unit 14 may receive the delivery information from the server 3 or an external computer, and store the received delivery information in the delivery information storage unit 131.

The display 15 is, for example, a liquid crystal display device, and outputs the stop place by displaying the location of the stop place.

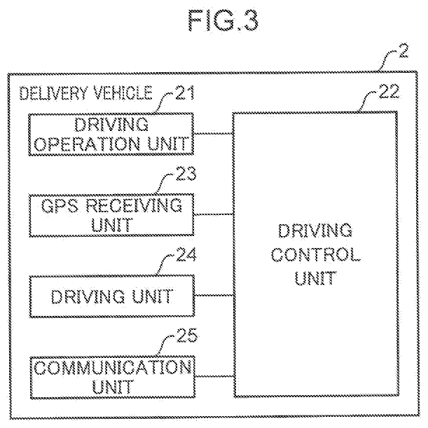

FIG. 3 is a diagram illustrating an example of a configuration of a delivery vehicle according to the first embodiment of the present disclosure.

The delivery vehicle 2 illustrated in FIG. 3 includes a driving operation unit 21, a driving control unit 22, a global positioning system (GPS) receiving unit 23, a driving unit 24, and a communication unit 25.

The driving operation unit 21 receives a driving operation of the delivery vehicle 2 performed by the deliverer.

The driving control unit 22 is, for example, a CPU, and controls the driving unit 24 according to the driving operation of the deliverer received by the driving operation unit 21 to move the delivery vehicle 2.

The GPS receiving unit 23 acquires a current location of the delivery vehicle 2. The current location is represented by latitude and longitude.

The driving unit 24 is, for example, a traveling motor and a transmission, and moves the delivery vehicle 2 under the control of the driving control unit 22.

The communication unit 25 transmits current location information indicating the current location acquired by the GPS receiving unit 23 to the delivery information terminal 1.

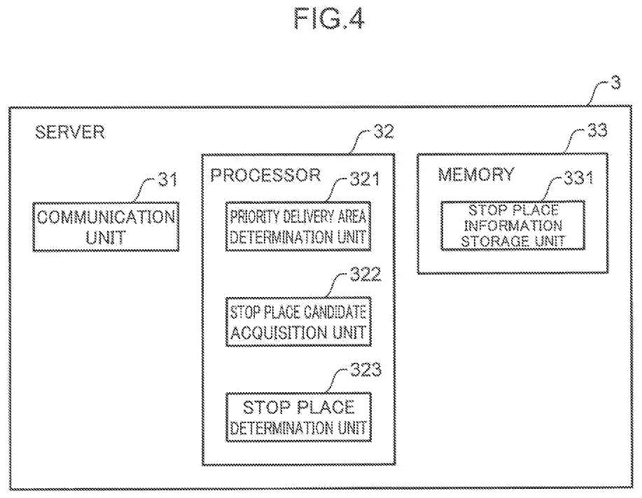

FIG. 4 is a diagram illustrating an example of a configuration of a server in the first embodiment of the present disclosure.

The server 3 illustrated in FIG. 4 includes a communication unit 31, a processor 32, and a memory 33.

The communication unit 31 receives the delivery destination information indicating the delivery destination belonging to the priority delivery group from the delivery information terminal 1. The communication unit 31 also transmits the stop place location information indicating the location of the stop place of the delivery vehicle 2 to the delivery information terminal 1.

The memory 33 is a storage device capable of storing various kinds of information, such as a RAM, a hard disk drive (HDD), an SSD, or a flash memory. The memory 33 includes a stop place information storage unit 331.

The stop place information storage unit 331 stores the stop place information in advance. The stop place information includes, for example, a stop place ID for identifying a stop place and a location of the stop place. The location of the stop place indicates the address of the stop place or the latitude and longitude of the stop place. The stop place information storage unit 331 stores stop place information in which the stop place ID and the location of the stop place are associated with each other in a table format in advance. The communication unit 31 may receive the stop place information from an external computer, and store the received stop place information in the stop place information storage unit 331.

The processor 32 is, for example, a CPU, and includes a priority delivery area determination unit 321, a stop place candidate acquisition unit 322, and a stop place determination unit 323.

The priority delivery area determination unit 321 determines a priority delivery area corresponding to the priority delivery group. The priority delivery area has a size and a shape including all the delivery destinations belonging to the priority delivery group. For example, the priority delivery area determination unit 321 calculates a barycenter of locations of all the delivery destinations belonging to the priority delivery group, and determines an area within a circle having a predetermined radius centered on the calculated barycenter of the locations as the priority delivery area. The priority delivery area determination unit 321 may further increase the predetermined radius to widen the priority delivery area when all the delivery destinations belonging to the priority delivery group are not included in the area within the circle having the predetermined radius.

The priority delivery area determination unit 321 may determine, as the priority delivery area, an area within a circle centered on the calculated barycenter of the locations and having a radius of a distance between the center and a delivery destination at a location farthest from the barycenter of the locations among a plurality of delivery destinations belonging to the priority delivery group.

The stop place candidate acquisition unit 322 acquires a candidate for the stop place for the delivery vehicle 2, which delivers a plurality of packages, to stop. The stop place candidate acquisition unit 322 acquires a candidate for the stop place in the priority delivery area determined by the priority delivery area determination unit 321. The stop place candidate acquisition unit 322 acquires a candidate for the stop place from the stop place information storage unit 331.

The stop place determination unit 323 determines a stop place for the priority delivery group based on a location of at least one delivery destination belonging to the priority delivery group and the candidates for the stop place. The stop place determination unit 323 determines the stop place based on a distance from each of the candidates for the stop place to at least one delivery destination belonging to the priority delivery group.

For example, the stop place determination unit 323 may calculate a distance of a route from departure from each of the candidates for the stop place to return to the corresponding one of the candidates for the stop place through all the delivery destinations belonging to the priority delivery group. The stop place determination unit 323 may determine, as the stop place, one of the candidates for the stop place, corresponding to a route having the shortest calculated distance among all routes. The stop place determination unit 323 also may sum distances from the candidates for the stop place to all the delivery destinations belonging to the priority delivery group. The stop place determination unit 323 may calculate a total distance for every candidate for the stop place and determine one of the candidates for the stop place having the shortest total distance as the stop place. The distance may be a distance to move along the road or may be a direct distance.

The stop place determination unit 323 outputs the stop place location information indicating the determined location of the stop place to the communication unit 31.

Subsequently, stop place presentation processing of the delivery information terminal 1 and the server 3 in the first embodiment of the present disclosure will be described.

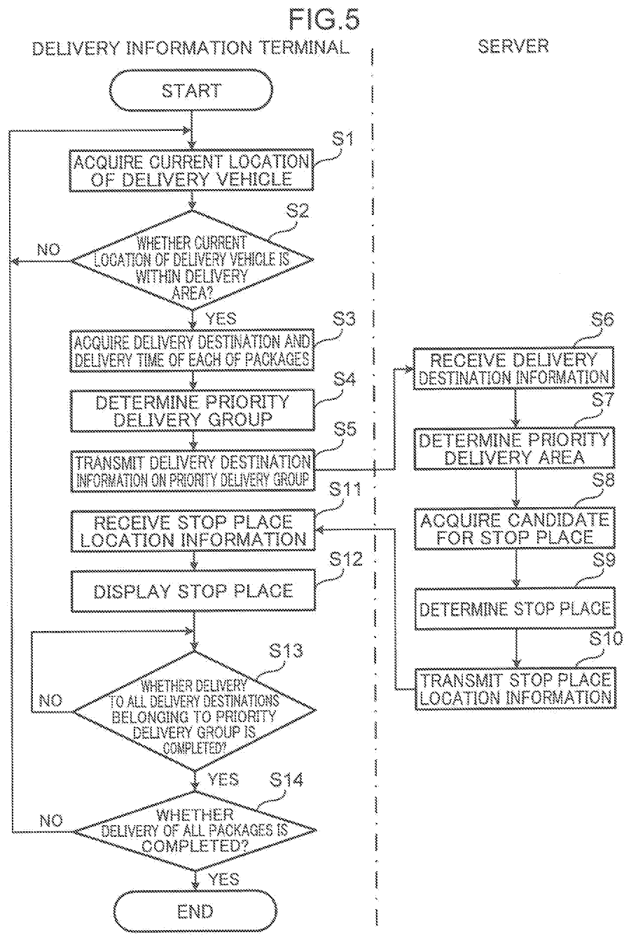

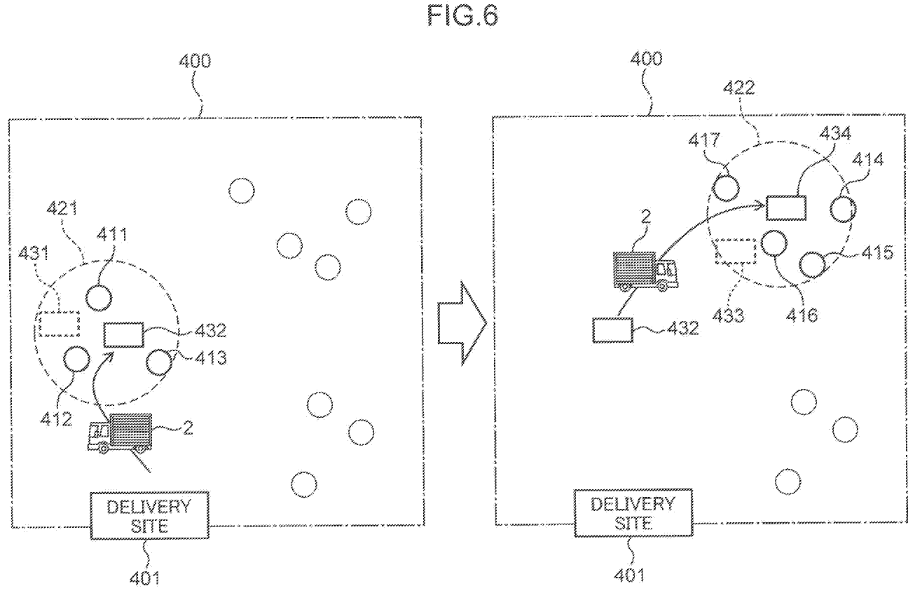

FIG. 5 is a flowchart for illustrating the stop place presentation processing of the delivery information terminal and the server in the first embodiment of the present disclosure. FIG. 6 is a schematic diagram for illustrating the stop place presentation processing in the first embodiment of the present disclosure.

In step S1, the current location acquisition unit 121 of the delivery information terminal 1 first acquires the current location information of the delivery vehicle 2 from the communication unit 14. The communication unit 14 receives the current location information of the delivery vehicle 2 from the delivery vehicle 2. The current location information may be periodically transmitted by the delivery vehicle 2, or may be transmitted by the delivery vehicle 2 in response to a request from the delivery information terminal 1. Additionally, the input unit 11 of the delivery information terminal 1 may include a button for accepting start of the stop place presentation processing. When the button is pressed by the deliverer, processing of step S1 may be performed.

The delivery information terminal 1 may include a GPS receiving unit. In this case, the current location acquisition unit 121 can acquire the current location of the delivery vehicle 2 by acquiring the current location from the GPS receiving unit of the delivery information terminal 1 while the delivery information terminal 1 exists inside or near the delivery vehicle 2.

In step S2, the delivery information acquisition unit 122 subsequently determines whether the current location of the delivery vehicle 2 is within the delivery area. As illustrated in FIG. 6, a delivery area 400 is allocated to the delivery vehicle 2. The delivery vehicle 2 loads a plurality of packages at a delivery site 401 and delivers the plurality of packages in the delivery area 400.

Here, when it is determined that the current location of the delivery vehicle 2 is not within the delivery area (NO in step S2), processing returns to step S1.

In contrast, when it is determined that the current location of the delivery vehicle 2 is within the delivery area (YES in step S2), in step S3, the delivery information acquisition unit 122 acquires a delivery destination and a delivery time of each of the packages from the delivery information storage unit 131.

In step S4, the priority delivery group determination unit 123 subsequently determines the priority delivery group to which at least one delivery destination belongs based on the current location of the delivery vehicle 2, the location of each delivery destination, and the delivery time to each delivery destination. The priority delivery group determination unit 123 extracts at least one delivery destination in which a distance between the location of the delivery destination and the current location of the delivery vehicle 2 is within a predetermined distance and in which the delivery time zone includes the current time, and determines a priority delivery group to which the extracted at least one delivery destination belongs. FIG. 6 illustrates delivery destinations 411, 412, and 413 that are determined as a priority delivery group.

The priority delivery group determination unit 123 may determine at least one delivery destination existing in an identical apartment building as the priority delivery group.

In step S5, the communication unit 14 subsequently transmits the delivery destination information indicating the delivery destination belonging to the priority delivery group to the server 3.

In step S6, the communication unit 31 of the server 3 subsequently receives the delivery destination information transmitted by the delivery information terminal 1.

In step S7, the priority delivery area determination unit 321 subsequently determines a priority delivery area corresponding to the priority delivery group based on the delivery destination information received by the communication unit 31. As illustrated in FIG. 6, the priority delivery area determination unit 321 calculates a barycenter of locations of all the delivery destinations 411, 412, and 413 belonging to the priority delivery group, and determines an area within a circle having a predetermined radius centered on the calculated barycenter of the locations as a priority delivery area 421.

The priority delivery area 421 is not limited to a circular shape, and may have another shape such as a quadrangular shape. The priority delivery area determination unit 321 also may determine, from addresses of the delivery destinations 411, 412, and 413, an area including the addresses to which all the delivery destinations 411, 412, and 413 belong as the priority delivery area 421.

In step S8, the stop place candidate acquisition unit 322 subsequently acquires a candidate for the stop place in the priority delivery area, which is determined by the priority delivery area determination unit 321, from the stop place information storage unit 331. In FIG. 6, the candidates 431 and 432 of the stop place existing in the priority delivery area 421 are acquired.

In step S9, the stop place determination unit 323 subsequently determines a stop place for the priority delivery group based on a distance from each of the candidates for the stop place to at least one delivery destination belonging to the priority delivery group. For example, the stop place determination unit 323 calculates a distance of a route from departure from each of the candidates for the stop place to return to the corresponding one of the candidates for the stop place through all the delivery destinations belonging to the priority delivery group. The stop place determination unit 323 determines, as the stop place, one of the candidates for the stop place, corresponding to one of the routes having the shortest calculated distance among all the routes.

In FIG. 6, the stop place determination unit 323 calculates a distance of a first route from departure from the candidate 431 for the stop place to return to the candidate 431 for the stop place through all the delivery destinations 411, 412, and 413 belonging to the priority delivery group. The stop place determination unit 323 also calculates a distance of a second route from departure from the candidate 432 for the stop place to return to the candidate 432 for the stop place through all the delivery destinations 411, 412, and 413 belonging to the priority delivery group. The stop place determination unit 323 determines, as the stop place, the candidate 432 for the stop place, corresponding to the second route having the shortest calculated distance between the first route and the second route.

In step S10, the communication unit 31 subsequently transmits the stop place location information indicating the location of the stop place determined by the stop place determination unit 323 to the delivery information terminal 1.

In step S11, the communication unit 14 of the delivery information terminal 1 subsequently receives the stop place location information transmitted by the server 3.

In step S12, the stop place display control unit 124 subsequently causes the display 15 to display the location of the stop place for the delivery vehicle 2 to stop. At this time, the stop place display control unit 124 may cause the display 15 to display the location of the stop place on a map, or may cause the display 15 to display the address of the stop place. The stop place display control unit 124 also may cause the display 15 to display not only the stop place 432 but also the delivery destinations 411, 412, and 413, the candidate 431 of the stop place, and the priority delivery area 421 as illustrated in FIG. 6.

The deliverer moves the delivery vehicle 2 toward the stop place 432 displayed on the display 15. Then, when the delivery vehicle 2 arrives at the stop place 432, the deliverer delivers a package to each of the delivery destinations 411, 412, and 413. The input unit 11 receives an input as to whether the delivery of the package has been completed at each of the delivery destinations 411, 412, and 413. When the input unit 11 receives whether the delivery of the package is completed, a delivery status of the delivery information storage unit 131 is updated. For example, when the delivery of the package to the delivery destination is completed, a delivery status corresponding to the delivery destination in the delivery information storage unit 131 is changed from “undelivered” to “delivery completion”. When a recipient is absent from the delivery destination, the delivery status of the delivery information storage unit 131 may be changed from “undelivered” to “re-delivery”.

In step S13, the current location acquisition unit 121 subsequently refers to the delivery status of the delivery information storage unit 131 and determines whether the delivery to all the delivery destinations belonging to the priority delivery group has been completed. Here, when it is determined that the delivery to all the delivery destinations belonging to the priority delivery group is not completed (NO in step S13), the processing in step S13 is repeated until the delivery to all the delivery destinations belonging to the priority delivery group is completed.

The delivery statuses of all the delivery destinations are not necessarily “delivery completion”, and when the delivery statuses of all the delivery destinations are not “undelivered”, the current location acquisition unit 121 may determine that the delivery to all the delivery destinations belonging to the priority delivery group has been completed.

In contrast, when it is determined that the delivery to all the delivery destinations belonging to the priority delivery group has been completed (YES in step S13), in step S14, the current location acquisition unit 121 refers to the delivery status of the delivery information storage unit 131 and determines whether the delivery of all the packages has been completed. Here, when it is determined that the delivery of all the packages has been completed (YES in step S14), the processing ends.

In contrast, when it is determined that the delivery of all the packages is not completed (NO in step S14), the processing returns to step S1. Then, a priority delivery group of the remaining packages that have not been delivered among the plurality of packages is determined, and a stop place for the priority delivery group is determined.

For example, when the delivery to all the delivery destinations 411, 412, and 413 belonging to the priority delivery group is completed in the stop place 432 illustrated in FIG. 6, the current location acquisition unit 121 acquires the current location information of the delivery vehicle 2 from the communication unit 14. At this time, the current location information indicates the stop place 432. When it is determined that the current location of the delivery vehicle 2 is within the delivery area 400, the delivery information acquisition unit 122 acquires a delivery destination and a delivery time of each of undelivered packages from the delivery information storage unit 131. The priority delivery group determination unit 123 subsequently extracts delivery destinations 414, 415, 416, and 417 in which a distance between a location of each delivery destination and the current location (stop place 432) of the delivery vehicle 2 is within a predetermined distance and a delivery time zone includes the current time, and determines a priority delivery group to which the extracted delivery destinations 414, 415, 416, and 417 belongs.

Then, the priority delivery area determination unit 321 of the server 3 calculates a barycenter of all the delivery destinations 414, 415, 416, and 417 belonging to the priority delivery group, and determines an area within a circle having a predetermined radius centered on the calculated center of gravity location as the priority delivery area 422. Next, the stop place candidate acquisition unit 322 acquires candidates 433 and 434 for the stop place present in the priority delivery area 422, which are determined by the priority delivery area determination unit 321, from the stop place information storage unit 331. Subsequently, the stop place determination unit 323 determines the stop place based on distances from the stop place candidates 433 and 434 to the respective delivery destinations 414, 415, 416, and 417 belonging to the priority delivery group. In FIG. 6, the stop place determination unit 323 determines the candidate 434 for a stop place as the stop place.

Then, the stop place display control unit 124 of the delivery information terminal 1 causes the display 15 to display the location of the stop place for the delivery vehicle 2 to stop. The deliverer moves the delivery vehicle 2 toward the stop place 434 displayed on the display 15.

As described above, a group to which at least one delivery destination belongs is determined based on a location of each delivery destination, and a stop place is determined for each group based on each location of at least one delivery destination belonging to the group and candidates for the stop place. Thus, the delivery vehicle 2, which delivers a plurality of packages, can be guided to the stop place suitable for delivery. Additionally, a package is delivered to at least one delivery destination belonging to the group from the stop place as a base, so that a plurality of packages can be delivered more efficiently.

Although in the present first embodiment, the stop place information associates the stop place ID with the location of the stop place, the present disclosure is not particularly limited to this association, and a stop state indicating whether a vehicle is currently stopped at the stop place may be further associated with the stop place ID and the location of the stop place. In this case, the stop place is provided with a sensor that detects whether the vehicle is stopped, and the server 3 receives a signal indicating whether the vehicle is stopped from the sensor. When acquiring candidates for the stop place from the stop place information storage unit 331, the stop place candidate acquisition unit 322 excludes a stop place at which the vehicle is currently stopped from the candidates for the stop place, and acquires a stop place at which the vehicle is not currently stopped as a candidate for the stop place.

In the present first embodiment, the server 3 may include a movement plan creation unit that creates a movement plan for passing through the stop place determined by the stop place determination unit 323. The movement plan creation unit predicts a movement route from the current location to the stop place. The movement plan creation unit predicts the movement route using a best priority search algorithm. The best priority search algorithm is, for example, Dijkstra's algorithm, A*algorithm, or uniform cost search. The communication unit 31 transmits the movement plan created by the movement plan creation unit to the delivery information terminal 1. The display 15 of the delivery information terminal 1 outputs the movement plan received by the communication unit 14.

When the delivery vehicle 2 is an electric vehicle in the present first embodiment, the stop place determination unit 323 may acquire remaining capacity of a battery mounted on the delivery vehicle 2 and determine the stop place by further using the remaining capacity of the battery. That is, the stop place determination unit 323 may determine a stop place capable of charging when the remaining capacity of the battery is equal to or less than a threshold. The stop place information may associate the stop place ID with the location of the stop place and charging information indicating whether there is a charging facility. When the remaining capacity of the battery is equal to or less than the threshold, the stop place determination unit 323 may determine the stop place having the charging facility among candidates for the stop place. When the remaining capacity of the battery is equal to or less than the threshold, the stop place determination unit 323 also may determine the stop place to which a travel distance is the shortest. The stop place candidate acquisition unit 322 may acquire a stop place having a charging facility in the priority delivery area as a candidate for the stop place.

In the present first embodiment, the processor 32 of the server 3 may include the current location acquisition unit 121, the delivery information acquisition unit 122, and the priority delivery group determination unit 123 of the processor 12 of the delivery information terminal 1, and the memory 33 of the server 3 may include the delivery information storage unit 131 of the memory 13 of the delivery information terminal 1.

### Second Embodiment

In the present first embodiment, every time the delivery vehicle 2 moves to the stop place, a subsequent priority delivery group is determined and a subsequent stop place is determined. In contrast, delivery groups are first determined in the second embodiment, and stop places for the respective delivery groups are determined.

An information processing system in the second embodiment includes a delivery information terminal 1A, a delivery vehicle 2, and a server 3A. The delivery vehicle 2 in the second embodiment is identical in configuration to the delivery vehicle 2 in the first embodiment. In the second embodiment, the same components as those in the first embodiment are denoted by the same reference numerals, and duplicated description thereof will be eliminated.

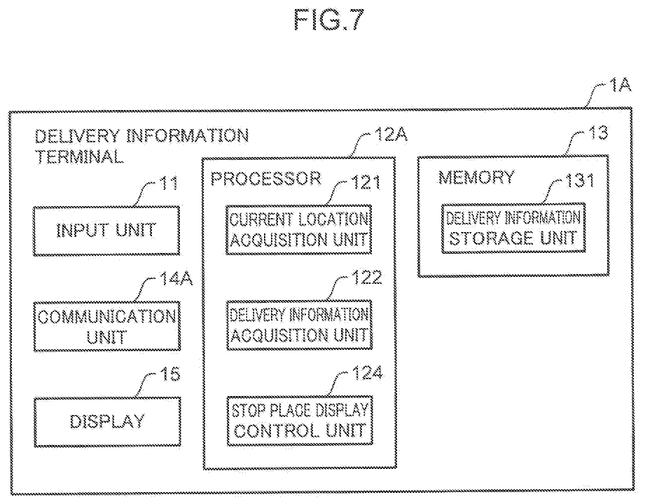

FIG. 7 is a diagram illustrating an example of the configuration of the delivery information terminal according to the second embodiment of the present disclosure.

The delivery information terminal 1A illustrated in FIG. 7 includes an input unit 11, a processor 12A, a memory 13, a communication unit 14A, and a display 15.

The processor 12A is, for example, a CPU, and includes a current location acquisition unit 121, a delivery information acquisition unit 122, and a stop place display control unit 124.

The communication unit 14A transmits information to the server 3A and receives information from the server 3A and the delivery vehicle 2. The communication unit 14A receives current location information indicating a current location of the delivery vehicle 2 from the delivery vehicle 2. The communication unit 14A transmits delivery destination information indicating a delivery destination of each of packages and delivery time information indicating a delivery time of each of the packages to the server 3A. The communication unit 14A receives stop place location information indicating locations of respective stop places of the delivery vehicle 2 from the server 3A. The communication unit 14A may receive the delivery information from the server 3A or an external computer and store the received delivery information in a delivery information storage unit 131.

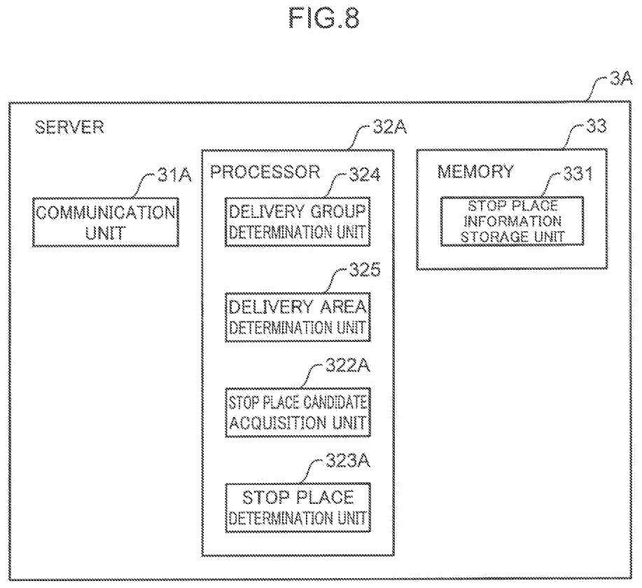

FIG. 8 is a diagram illustrating an example of a configuration of a server in the second embodiment of the present disclosure.

The server 3A illustrated in FIG. 8 includes a communication unit 31A, a processor 32A, and a memory 33.

The communication unit 31A receives delivery destination information indicating a delivery destination of each of packages and delivery time information indicating a delivery time of each of the packages from the delivery information terminal 1A. The communication unit 31A also transmits the stop place location information indicating locations of respective stop places of the delivery vehicle 2 to the delivery information terminal 1A.

The processor 32A is, for example, a CPU, and includes a delivery group determination unit 324, a delivery area determination unit 325, a stop place candidate acquisition unit 322A, and a stop place determination unit 323A.

The delivery group determination unit 324 determines a delivery group to which at least one delivery destination belongs based on a location of each delivery destination and a delivery time to each delivery destination. The delivery group determination unit 324 distributes delivery destinations to respective delivery groups. The delivery group determination unit 324 determines delivery groups in which at least one of delivery destinations, which are at respective locations within a predetermined distance and are in an identical delivery time zone, is set as one of the delivery groups.

The delivery area determination unit 325 determines delivery areas corresponding to the respective delivery groups. Each of the delivery areas has a size and a shape including all the delivery destinations belonging to corresponding one of the delivery groups. For example, the delivery area determination unit 325 calculates a barycenter of locations of all the delivery destinations belonging to the corresponding one of the delivery groups, and determines an area within a circle having a predetermined radius centered on the calculated barycenter of the locations as corresponding one of the delivery areas. The delivery area determination unit 325 may further increase the predetermined radius to widen a delivery area when all delivery destinations belonging to a delivery group are not included in the area within the circle having the predetermined radius.

The delivery area determination unit 325 may determine, as the delivery area, an area within a circle centered on the calculated barycenter of the locations and having a radius of a distance between the center and a delivery destination at a location farthest from the barycenter of the locations among a plurality of delivery destinations belonging to the delivery group.

The stop place candidate acquisition unit 322A acquires a candidate for a stop place for the delivery vehicle 2 to stop. The stop place candidate acquisition unit 322A acquires a candidate for a stop place present in each of the delivery areas determined by the delivery area determination unit 325. The stop place candidate acquisition unit 322A acquires a candidate for the stop place from a stop place information storage unit 331.

The stop place determination unit 323A determines stop places for the respective delivery groups based on a location of at least one delivery destination belonging to corresponding one of the delivery groups and the candidates for the respective stop places. The stop place determination unit 323A determines the stop place based on a distance from each of the candidates for the stop place to at least one delivery destination belonging to the delivery group.

For example, the stop place determination unit 323A may calculate a distance of a route from departure from each of the candidates for the stop place to return to the corresponding one of the candidates for the stop place through all the delivery destinations belonging to the priority delivery group. The stop place determination unit 323A may determine, as the stop place, one of the candidates for the stop place, corresponding to a route having the shortest calculated distance among all routes. The stop place determination unit 323A also may sum distances from the candidates for the stop place to all the delivery destinations belonging to the delivery group. The stop place determination unit 323A may calculate a total distance for every candidate for the stop place and determine one of the candidates for the stop place having the shortest total distance as the stop place. The distance may be a distance to move along the road or may be a direct distance.

Subsequently, stop place presentation processing of the delivery information terminal 1A and the server 3A in the second embodiment of the present disclosure will be described.

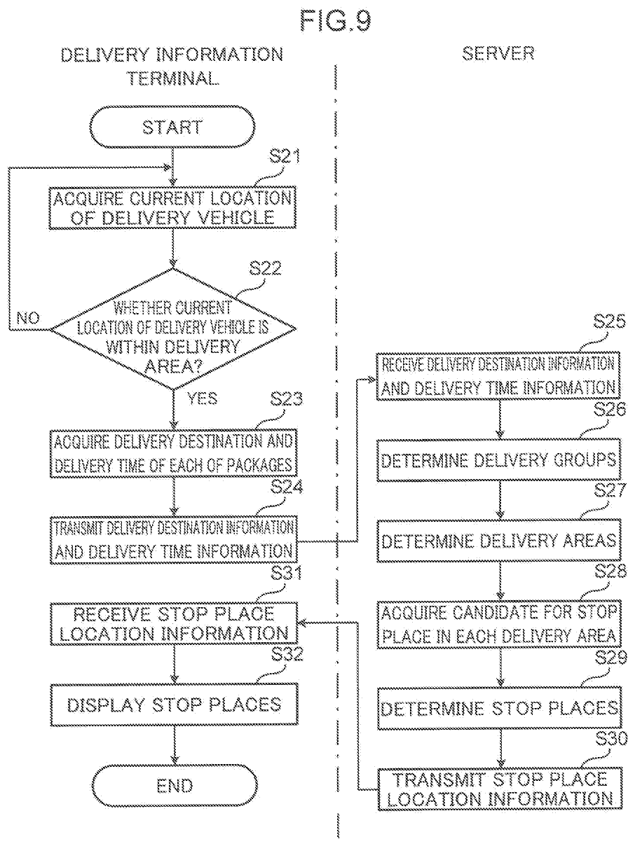

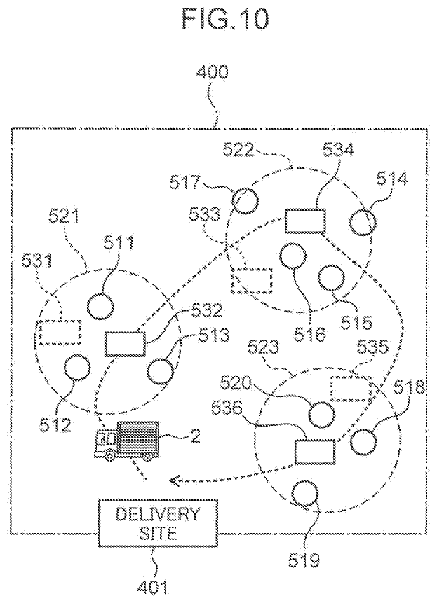

FIG. 9 is a flowchart for illustrating stop place presentation processing of the delivery information terminal and the server in the second embodiment of the present disclosure. FIG. 10 is a schematic diagram for illustrating the stop place presentation processing in the second embodiment of the present disclosure.

Processing in steps S21 to S23 is the same as the processing in steps S1 to S3 illustrated in FIG. 5, so that description of the processing will be eliminated.

In step S24, the communication unit 14A subsequently transmits delivery destination information indicating a delivery destination of each of packages and delivery time information indicating a delivery time of each of the packages to the server 3A.

In step S25, the communication unit 31A of the server 3A subsequently receives the delivery destination information and the delivery time information transmitted by the delivery information terminal 1A.

In step S26, the delivery group determination unit 324 subsequently determines delivery groups to each of which at least one delivery destination belongs based on a location of each deliver destination and a delivery time to each deliver destination. The delivery group determination unit 324 determines delivery groups in which at least one of delivery destinations, which are at respective locations within a predetermined distance and are in an identical delivery time zone, is set as one of the delivery groups. FIG. 10 illustrates delivery destinations 511, 512, and 513 that are determined as a first delivery group, delivery destinations 514, 515, 516, and 517 that are determined as a second delivery group, and delivery destinations 518, 519, and 520 that are determined as a third delivery group.

In step S27, the delivery area determination unit 325 subsequently determines delivery areas corresponding to the respective delivery groups. As illustrated in FIG. 10, the delivery area determination unit 325 calculates a barycenter of locations of all the delivery destinations 511, 512, and 513 belonging to the first delivery group, and determines an area within a circle having a predetermined radius centered on the calculated barycenter of the locations as a first delivery area 521. The delivery area determination unit 325 also calculates a barycenter of locations of all the delivery destinations 514, 515, 516, and 517 belonging to the second delivery group, and determines an area within a circle having a predetermined radius centered on the calculated barycenter of the locations as a second delivery area 522. The delivery area determination unit 325 further calculates a barycenter of locations of all the delivery destinations 518, 519, and 520 belonging to the third delivery group, and determines an area within a circle having a predetermined radius centered on the calculated barycenter of the locations as a third delivery area 523.

The first delivery area 521, the second delivery area 522, and the third delivery area 523 are each not limited to a circular shape, and may have another shape such as a quadrangular shape. The delivery area determination unit 325 also may determine, from addresses of the delivery destinations, an area including the addresses to which all the delivery destinations belong as a delivery area.

In step S28, the stop place candidate acquisition unit 322A subsequently acquires a candidate for the stop place in the delivery area, which is determined by the delivery area determination unit 325, from the stop place information storage unit 331. FIG. 10 illustrates candidates 531 and 532 for the stop place present in the first delivery area 521 that are to be acquired, candidates 533 and 534 for the stop place present in the second delivery area 522 that are to be acquired, and candidates 535 and 536 for the stop place present in the third delivery area 523 that are to be acquired.

In step S29, the stop place determination unit 323A determines stop places for respective delivery groups based on a distance from each of the candidates for the corresponding one of the stop places to at least one delivery destination belonging to the corresponding one of the delivery groups. For example, the stop place determination unit 323A calculates a distance of a route from departure from each of the candidates for the corresponding one of the stop places to return to the corresponding one of the candidates for the corresponding one of the stop places through all the delivery destinations belonging to the corresponding one of the delivery groups. The stop place determination unit 323A determines, as the stop place, one of the candidates for the corresponding one of the stop places, corresponding to one of the routes having the shortest calculated distance among all the routes.

In FIG. 10, the stop place determination unit 323A calculates a distance of a first route from departure from the candidate 531 for the stop place to return to the candidate 531 for the stop place through all the delivery destinations 511, 512, and 513 belonging to the first delivery group. The stop place determination unit 323A also calculates a distance of a second route from departure from the candidate 532 for the stop place to return to the candidate 532 for the stop place through all the delivery destinations 511, 512, and 513 belonging to the first delivery group. The stop place determination unit 323A determines, as the stop place, the candidate 532 for the stop place, corresponding to the second route having the shortest calculated distance between the first route and the second route. Similarly, the stop place determination unit 323A determines the stop place 534 for the second delivery group and determines the stop place 536 for the third delivery group.

In step S30, the communication unit 31A subsequently transmits stop place location information indicating the locations of the respective stop places determined by the stop place determination unit 323A to the delivery information terminal 1A.

In step S31, the communication unit 14A of the delivery information terminal 1A subsequently receives the stop place location information transmitted by the server 3A.

In step S32, the stop place display control unit 124 subsequently causes the display 15 to display the locations of the respective stop places for the delivery vehicle 2 to stop. At this time, the stop place display control unit 124 may cause the display 15 to display the locations of the respective stop places on a map, or may cause the display 15 to display the addresses of the respective stop places. The stop place display control unit 124 also may cause the display 15 to display not only the stop places 532, 534, and 536 but also the delivery destinations 511 to 520, the candidates 531, 533, and 535 for the respective stop places, the first delivery area 521, the second delivery area 522, and the third delivery area 523, as illustrated in FIG. 10.

In the present second embodiment, the delivery group determination unit 324 may determine a delivery group to which at least one delivery destination belongs based on the location of each delivery destination. That is, the delivery group determination unit 324 may determine delivery groups based on only the location of each delivery destination without considering a delivery time to each delivery destination.

In the present second embodiment, the server 3A may include a movement plan creation unit that creates a movement plan for passing through stop places determined by the stop place determination unit 323A. The movement plan creation unit predicts a movement route passing through each of the stop places from the current location. The movement plan creation unit predicts the movement route using a best priority search algorithm. The best priority search algorithm is, for example, Dijkstra's algorithm, A*algorithm, or uniform cost search. The communication unit 31A transmits the movement plan created by the movement plan creation unit to the delivery information terminal 1A. The display 15 of the delivery information terminal 1A outputs the movement plan received by the communication unit 14A.

In the present second embodiment, the server 3A may include a movement plan creation unit that creates a movement plan of the delivery vehicle 2. In this case, the movement plan creation unit creates a movement plan for passing through delivery areas determined by the delivery area determination unit 325. For example, the movement plan creation unit creates a movement plan for passing through the center of each of the delivery areas in a circular shape. Then, the stop place determination unit 323A may determine stop places for the respective delivery groups based on a location of at least one delivery destination belonging to corresponding one of the delivery groups, the candidates for the respective stop places, and the movement plan. When the movement plan is further used, the stop place determination unit 323A determines, as the stop place, a candidate for the stop place closest to the movement route among candidates for the stop place.

Although in the second embodiment, the stop place information associates the stop place ID with the location of the stop place, the present disclosure is not particularly limited to this association, and a scheduled stop time indicating a scheduled time for the vehicle to stop at the stop place may be further associated with the stop place ID and the location of the stop place. In this case, when stop places are determined, the server 3A may calculate an estimated time of arrival at each of the stop places from the current location based on the current location, the locations of the respective stop places, and the locations of the respective delivery destinations, and may store a predetermined time including the calculated estimated time of arrival as a scheduled stop time in association with each of the stop places. The predetermined time is, for example, a time from 30 minutes before the estimated time of arrival to 30 minutes after the estimated time of arrival. When acquiring candidates for the stop place from the stop place information storage unit 331, the stop place candidate acquisition unit 322 calculates the estimated time of arrival at which the delivery vehicle 2 arrives at the stop place. When the calculated estimated time of arrival is within the scheduled stop time for the vehicle, the stop place candidate acquisition unit 322 excludes the stop place from the candidates for the stop place and acquires a stop place at which the vehicle does not stop at the estimated time of arrival as a candidate for the stop place.

In the present second embodiment, the processor 32A of the server 3A may include the current location acquisition unit 121 and the delivery information acquisition unit 122 of the processor 12A of the delivery information terminal 1A, and the memory 33 of the server 3A may include the delivery information storage unit 131 of the memory 13 of the delivery information terminal 1A.

In each of the above embodiments, each component may be composed of dedicated hardware, or may be fabricated by executing a software program suitable for each component. Each component may be fabricated by a program execution unit such as a CPU or a processor reading and executing a software program recorded on a recording medium such as a hard disk or a semiconductor memory.

Some or all of functions of the devices according to the embodiments of the present disclosure are typically fabricated using a large scale integration (LSI) that is an integrated circuit. The functions may be individually integrated into one chip, or may be integrated into one chip including some or all of the functions. The integrated circuit is not limited to the LSI, and may be fabricated by a dedicated circuit or a general-purpose processor. A field programmable gate array (FPGA) that can be programmed after manufacturing an LSI, or a reconfigurable processor that can reconfigure connection and setting of circuit cells inside an LSI, may be used.

Additionally, some or all of functions of the devices according to the embodiments of the present disclosure may be implemented by a processor such as a CPU executing a program.

The numbers used above are merely examples for specifically describing the present disclosure, and the present disclosure is not limited to the illustrated numbers.

The order in which the steps shown in the above flowcharts are performed is merely an example for specifically describing the present disclosure, and any order other than the above may be available as long as a similar effect can be obtained. Some of the above steps may be performed simultaneously (in parallel) with another step.

### INDUSTRIAL APPLICABILITY

The technique according to the present disclosure is capable of guiding a mobile body that delivers a plurality of packages to a stop place suitable for delivery, and thus is useful as a technique for determining a stop place of a mobile body that delivers a plurality of packages.

1. An information processing method executed by a computer, the information processing method comprising:
acquiring a delivery destination of each of packages;
acquiring candidates for a stop place for a mobile body that delivers the packages to stop;
determining a group to which at least one delivery destination belongs based on a location of each of the delivery destinations;
determining the stop place for the group based on a location of the at least one delivery destination belonging to the group and the candidates for the stop place; and
outputting the stop place determined.

2. The information processing method according to claim 1, wherein
in the determining the stop place, the stop place is determined based on a distance from the candidate for the stop place to each of the at least one delivery destination belonging to the group.

3. The information processing method according to claim 1, further comprising:
determining an area corresponding to the group,
wherein in the acquiring the candidate for the stop place, a candidate for the stop place in the determined area is acquired.

4. The information processing method according to claim 1, further comprising:
acquiring a delivery time to each of the delivery destinations,
wherein in the determining the group, the group is determined based on a location of each of the delivery destinations and the delivery time to each of the delivery destinations.

5. The information processing method according to claim 4, further comprising:
acquiring a location of the mobile body,
wherein in the determining the group, the group is determined based on the location of the mobile body, a location of each of the delivery destinations, and the delivery time to each of the delivery destinations.

6. The information processing method according to claim 1, further comprising:
creating a movement plan passing through the stop place determined; and
outputting the movement plan created.

7. The information processing method according to claim 1, further comprising:
creating a movement plan of the mobile body,
wherein in determining the stop place, the stop place is determined by further using the movement plan.

8. The information processing method according to claim 1, further comprising:
acquires remaining capacity of a battery mounted on the mobile body that is an electric mobile body,
wherein in the determining the stop place, the stop place is determined by further using the remaining capacity of the battery.

9. The information processing method according to claim 8, wherein
in the determining the stop place, when the remaining capacity of the battery is equal to or less than a threshold, the stop place capable of charging is determined.

10. An information processing system comprising:
a delivery destination acquisition unit that acquires a delivery destination of each of packages;
a stop place candidate acquisition unit that acquires candidates for a stop place for a mobile body that delivers the packages to stop;
a group determination unit that determines a group to which at least one delivery destination belongs based on a location of each of the delivery destinations;
a stop place determination unit that determines a stop place for the group based on a location of the at least one delivery destination belonging to the group and the candidates for the stop place; and
an output unit that outputs the stop place determined.
